(19) United States
(12) Patent Application Publication
(10) Pub. No.: US 2005/0060231 A1
(43) Pub. Date: Mar. 17, 2005

(54) Gaming incentive system and method of redeeming bonus points

(75) Inventors: Thomas E. Soukup, Las Vegas, NV (US); Jeffrey George, Las Vegas, NV (US); Doug Huber, Louisville, KY (US); Zhiguo Huang, Henderson, NV (US); Michael D. Crittenden, Henderson, NV (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Konami Gaming, Inc., Las Vegas, NV (US)

(21) Appl. No.: 10/938,187

(22) Filed: Sep. 10, 2004

Related U.S. Application Data
(60) Provisional application No. 60/502,179, filed on Sep. 11, 2003.

(51) Int. Cl. G06F 17/60; A63F 9/24; A63F 13/00; G06F 17/00; G06F 19/00

(52) U.S. Cl. 705/14; 463/25

(57) ABSTRACT

A computerized gaming incentive system and method for redeeming bonus points from the system. The system includes a computer with a database for storing a plurality of vouchers. Each voucher includes a number of bonus points representing a monetary value. The system allows a user to select one voucher from the plurality of vouchers. When the voucher selected is a non-cashable voucher, the system produces a scrip wagerable at a table game and valued at the amount to be redeemed.

### CROSS-REFERENCE TO RELATED APPLICATIONS

This application claims priority to U.S. Provisional Application Ser. No. 60/502,179, filed Sep. 11, 2003, which is hereby incorporated by reference.

### FIELD OF THE INVENTION

The present invention relates generally to a computerized gaming incentive system and method of redeeming cashable or non-cashable equivalent electronic vouchers or awards.

### BACKGROUND OF THE INVENTION

The growth and competition in the casino gaming market in recent years and the increasingly sophisticated and complex technology being integrated into the gaming environment, at the individual game, casino management, and auditing levels, presents both challenges and opportunities to game manufacturers, gaming establishment operators, and regulatory agencies. The technological capabilities and requirements of, for example, advanced electronic games, multi-site gaming operations, detailed player tracking, wide area progressive jackpots, and various alternatives to the use of currency and coins by players, all present a potentially huge pool of ever-changing data which can be of great value to casino operators (from a management standpoint) and to regulators from an audit/compliance standpoint.

Players may be given an incentive through a player tracking club. Usually, a player is identified during play by a player tracking ID card and/or a player identification number (PIN). The player tracking system tracks the player's play and awards player tracking points according to established criteria. The player tracking points may be redeemed for prizes, such as complimentary meals or merchandise.

### SUMMARY OF THE INVENTION

The subject invention provides a method for redeeming bonus points from a computerized gaming incentive system. A player account associated with a player is maintained on the system. A non-cashable voucher is assigned to the player account. The non-cashable voucher includes a first number of bonus points representing a monetary value that may be wagered. The method includes the step of displaying to a user the non-cashable voucher, including the monetary value. The method also includes the steps of allowing the user to enter an amount to be redeemed from the non-cashable voucher and debiting a certain number of bonus points from the non-cashable voucher corresponding to the amount to be redeemed. The method further includes the step of producing a scrip wagerable at a table game and valued at the amount to be redeemed.

The subject invention also provides a method of redeeming bonus points from a computerized gaming incentive system. A player account associated with a player is maintained on the system. A plurality of vouchers are assigned to the player account. Each of the plurality of vouchers includes a number of bonus points representing a monetary value. The method includes the steps of displaying to a user a list of vouchers assigned to the player account and allowing the user to select a voucher to be redeemed from the plurality of vouchers displayed.

The subject invention further provides a gaming incentive system. The system includes a computer for tracking a player account. A database is stored on the computer for storing a plurality of vouchers. Each voucher includes a number of bonus points representing a monetary value. A terminal is coupled to the computer. The terminal includes a display for displaying to a user a list of vouchers assigned to the player account. The terminal also includes an input device for allowing the user to select a voucher to be redeemed from the plurality of vouchers displayed.

Accordingly, the subject invention provides an improved technique for redeeming bonus points. Furthermore, an additional incentive to using bonus points is provided by the subject invention.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is block diagram illustrating a gaming incentive system;

FIG. 2 is a diagrammatic illustration of a database maintaining a plurality of player accounts;

FIG. 3 is a diagrammatic illustration of the database maintaining a plurality of vouchers;

FIG. 4 is a perspective view of a terminal embodied as a stationary workstation;

FIG. 5 is a perspective view of the terminal embodied as a remote device;

FIG. 6 is a block diagram representing a screen image showing a search dialog;

FIG. 7 is a block diagram representing a screen image showing selection of one of the plurality of vouchers;

FIG. 8 is a block diagram representing a screen image showing entry of an amount to be redeemed from one of the plurality of vouchers;

FIG. 9 is a block diagram representing a screen image showing a monetary value of one of the plurality of vouchers after redemption;

FIG. 10 is an illustration of a receipt verifying the redemption;

FIG. 11 is a block diagram representing a screen image showing a PIN entry dialog; and

FIG. 12 is an illustration of a scrip that is wagerable and valued at the amount to be redeemed.

### DETAILED DESCRIPTION OF THE PREFERRED EMBODIMENT

With reference to the drawings and in operation, the present invention provides a computerized gaming incentive system 20 and method for redeeming bonus points from the system 20. The system 20 may include may include functions such as: real-time multi-site, slot accounting, player tracking, cage credit and vault, sports book data collection, point-of-sale (POS) accounting, keno accounting, bingo accounting, table game accounting, a wide area progressive jackpot, and electronic funds transfer (EFT). Two such systems 20 are disclosed in U.S. patent application Ser. No. 09/967,571, filed Sep. 28, 2001, and U.S. Provisional Application Ser. No. 60/502,179, filed Sep. 11, 2003, both of which are hereby incorporated by reference.

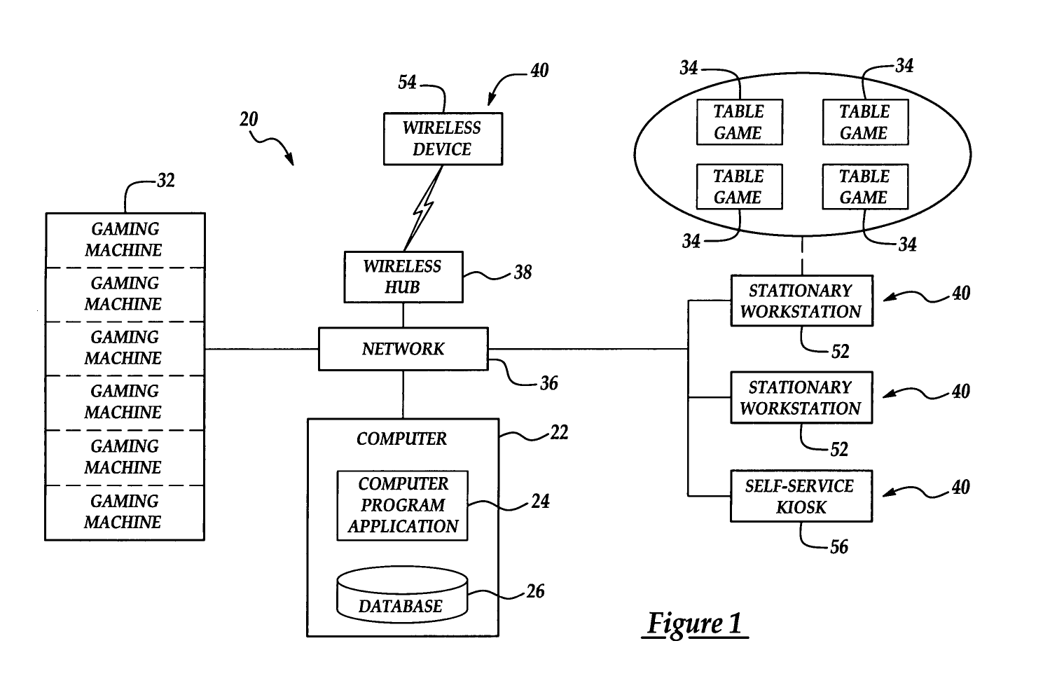

Referring to FIG. 1, the system 20 includes a computer 22. The computer 22 includes a computer program application 24 which maintains at least one database 26. The computer program application 24 and database 26 are used to track and maintain player accounts 28, as shown in FIG. 2. In one embodiment, the database 26 is an Oracle database 26.

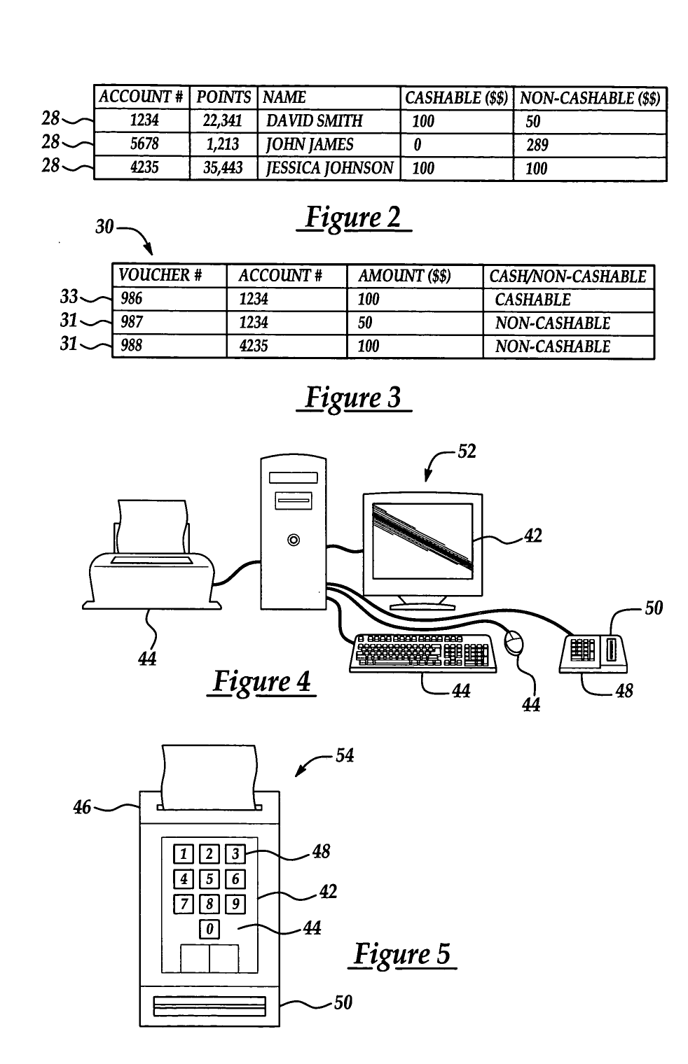

The database 26 also stores a plurality of vouchers 30, as seen in FIG. 3. Each voucher 30 includes a number of bonus points. The bonus points represent monetary value. Each voucher 30 is associated with one of the player accounts 28. Each player account 28 may be associated with one or more vouchers 30.

Numerous types of vouchers 30 may be maintained by the database 26 and the computer 22. A first type of voucher 30 maintained by the database 26 and the computer 22 is a non-cashable voucher 31. Non-cashable vouchers 31, like all vouchers 30, are assigned to player accounts 28. The non-cashable vouchers 31 include a first number of bonus points representing a monetary value. The monetary value of the non-cashable vouchers 31 cannot be exchanged for cash. However, the monetary value of the non-cashable vouchers 31 may be wagered at the gaming machines 32, table games 34, sports betting windows (not shown), etc. A second type of voucher 30 maintained by the database 26 and the computer 22 is a cashable voucher 33. Cashable vouchers 33 include a second number of bonus points which also represent a monetary value. However, the monetary value of the cashable vouchers 33 may be exchanged for cash, used as payment in a restaurant or gift shop, or otherwise wagered.

Referring again to FIG. 1, the system 20 includes a network 36 coupled to the computer 22 to facilitate data communications. Gaming machines 32 are typically coupled to the computer 22 via the network 36. One way a player can accumulate bonus points is by playing the gaming machines 32. Gaming machines 32 may include, but are not limited to, electronic gaming machines (such as video slot, video poker machines, or video arcade games), electric gaming machines, virtual gaming machines, e.g., for online gaming, and an interface to a table management system for table games 34.

The system 20 also includes at least one wireless hub 38 coupled to the computer 22 for transmitting and receiving data. In one embodiment, the wireless hub 38 utilizes one or more of the IEEE 802.11 protocols. However, those skilled in the art realize that the wireless hub 38 may be implemented using other protocols and techniques. These other protocols and techniques include, but are not limited to, infrared and Bluetooth.

At least one terminal 40 is coupled to the computer 22 via the network 36. The terminal 40 includes a display 42 and an input device 44. The input device 44 typically includes a keyboard and/or a pointing device, such as a mouse. The terminal 40 may also include a printer 46, a keypad 48, and a card reader 50. The terminal 40 may be implemented as a stationary workstation 52, as shown in FIG. 4. Stationary workstations 52 are typically located in table game “pits”, in cashier and change booths, and at various cash registers around the casino. The terminal 40 may also be implemented as a wireless device 54, such as a personal digital assistant (PDA), as shown in FIG. 5. The input device 44 of the wireless device 54 may be a touchscreen layered on top of the display 42. The wireless device 54 communicates with the wireless hub 38 and therefore is also coupled to the computer 22. The terminal 40 may also be implemented as a self-service kiosk 56. Of course, other implementations of the terminal 40 are known to those skilled in the art.

The subject invention provides a method for redeeming bonus points from the system 20 described above. A user operates the terminal 40 to redeem the bonus points. When the terminal is the self-service kiosk 56, the user may be the player. However, the user is typically a casino employee, such as a pit boss, a change attendant, or a cashier.

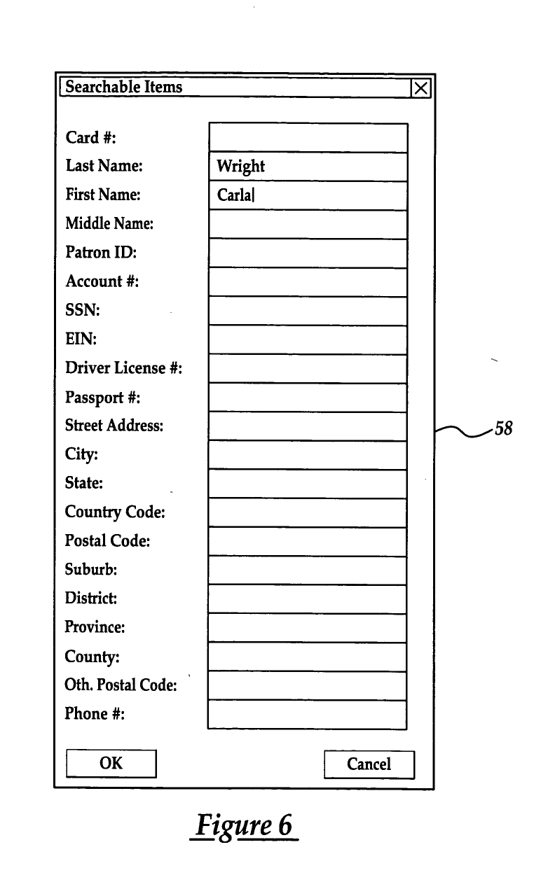

The user must first select the player account 30 from which bonus points are to be redeemed. A first way to select the player account 30 is to slide an ID card through the card scanner 50 on the terminal 40. The ID card is typically a “player's club card” issued to the player by the casino. An account number referencing the player account 30 is encoded on the card. A second way to select the player account 30 is to enter the account number using the input device 44 of the terminal 40. A third way to select the player account 30 is to utilize the search dialog 58 shown on the display 42, as referenced in FIG. 6. Information on the player, such as their first and last names, can be entered into the search dialog to locate the player account 30. Other information can also be used to search for the player, including, but not limited to, the player's social security number, drivers license number, passport number, address, and phone number.

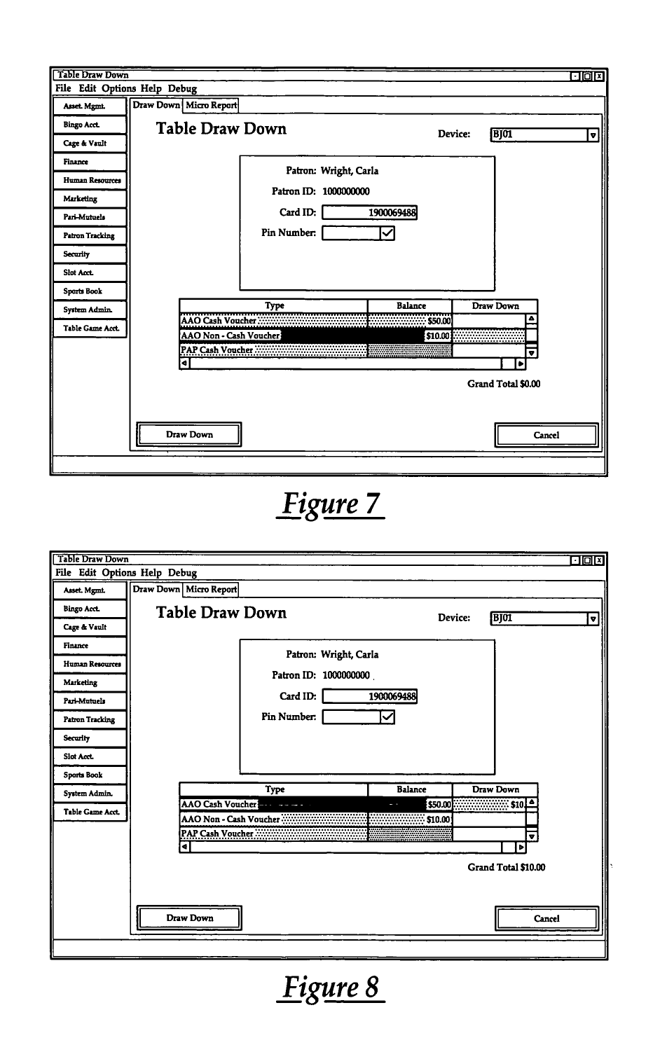

Once the player account 30 is selected, the display 42 shows the vouchers 30 assigned to the player account 30, as seen in FIG. 7. The terminal 40 allows the user to select a voucher 30 to be redeemed from the vouchers 30 displayed. The terminal 40 then allows the user to enter an amount to be redeemed from the voucher 30 selected. FIG. 8 shows an example where $10.00 is requested to be redeemed from a voucher having a monetary value of $50.00.

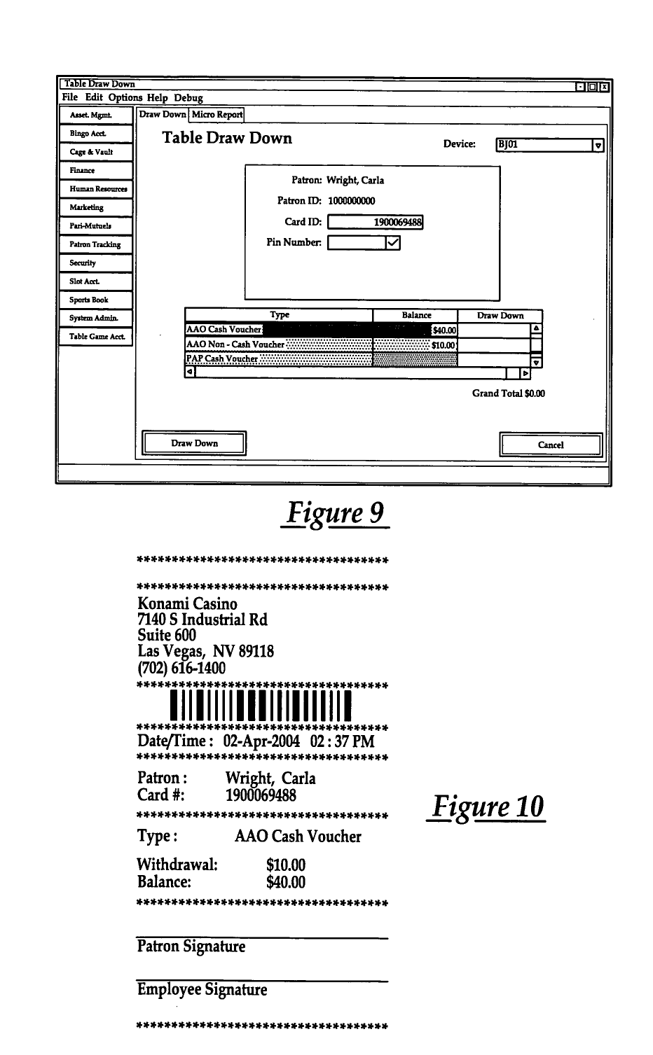

In a first embodiment, the computer 22 then debits a certain number of bonus points from the selected voucher 30 corresponding to the amount to be redeemed. The display 42 shows the updated monetary value of the voucher 30 from which the bonus points were redeemed. From the example above, FIG. 9 shows the voucher previously having a monetary value of $50.00 now only has a monetary value of $40.00. In the first embodiment, the voucher 30 stays active in the computer 22 until all of the bonus points are redeemed. Once all of the bonus points on the voucher 30 are redeemed, the voucher 30 is cancelled.

In a second embodiment, the computer 22 compares the bonus points requested to be redeemed from the bonus points available on the voucher 30. If the bonus points requested is less than the bonus points available, then the computer 22 creates a new voucher 30. The new voucher 30 has a new value of the bonus points available minus the bonus points requested. The old voucher 30 is then cancelled. If the bonus points requested are greater than the bonus points available, then the computer 22 cancels the voucher 30.

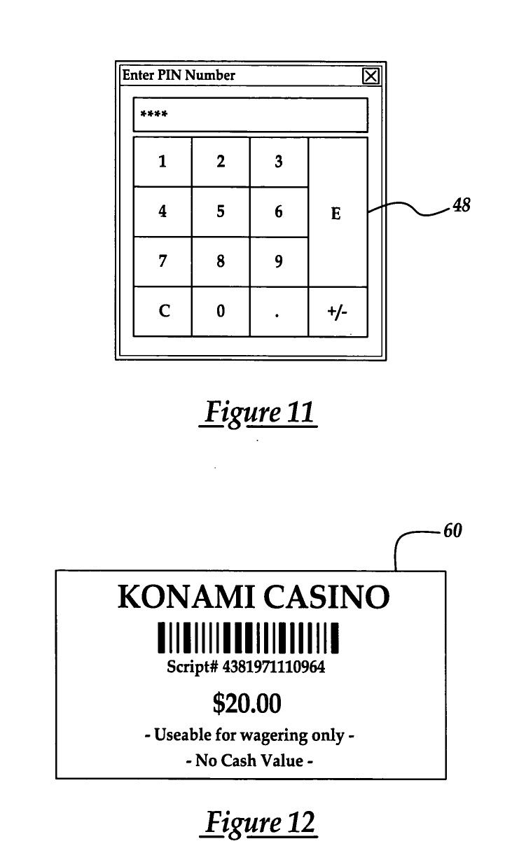

The system 20 may be configured to require the player to authorize the debiting of the certain number of bonus points before the bonus points are debited. In one embodiment, the terminal 40 allows the player to enter a personal identification number (PIN). The keypad 48 may be used by the player to enter the PIN. In the case of the remote device 54, the touchscreen may be used to display a keypad 48, as shown in FIG. 11. The computer then confirms the validity of the PIN by comparing the PIN entered in the keypad 48 to one stored in the player account in the database.

Another aspect of the method of the present invention is to allow a player to redeem a non-cashable voucher 31. The user will select a non-cashable voucher 31 and enter an amount to be redeemed from the non-cashable voucher 31. A certain number of bonus points are debited from the non-cashable voucher 31 corresponding to the amount to be redeemed. The system then produces a scrip 60 which is wagerable and valued at the amount to be redeemed. The scrip 60 is wagerable at a table game, a sports betting window, a gaming machine, etc. However, the scrip 60 is not exchangeable for cash. In one embodiment, the scrip 60 is a paper ticket produced by the printer of the terminal. An example of the scrip 60 in paper ticket form is shown in FIG. 12. In this embodiment, a name of the casino, a serial number, a bar code encoding the serial number, and a monetary value are printed on the scrip 60. The serial number and monetary value of the scrip 60 may be stored in the database 26 of the computer 22. However, those skilled in the art realize that other forms of the scrip 60 are possible. These other forms include, but are not limited to, a token, a marker, a specially marked chip, a chip having a specially coded RF tag, and a hand-written receipt.

As stated above, the player can use the scrip 60 to place a wager a table game 34. In a first example, the player could wager the scrip 60 at a blackjack table operated by a dealer. After the wager is made, a round of the blackjack is dealt by the dealer. If the player's cards beat the dealer's cards, then the dealer will pay the player the value of the scrip 60, while allowing the player to retain the scrip 60. However, if the player loses to the dealer, the scrip 60 is collected by the dealer. Typically, the scrip 60 is placed in a chute in the blackjack table and falls into a secure lock box. In a second example, the player could wager the scrip 60 at one of the gaming machines 32. The scrip 60 is first inserted into the gaming machine 32. The barcode and/or the serial number of the scrip 60 is read by the gaming machine 32 and verified against the database 26. The gaming machine 32 retains the scrip 60 and credits the player a certain number of credits corresponding to the value of the scrip 60. The player can then play the gaming machine 32 using the certain number of credits provided by the scrip 60. However, the player will not be permitted to simply “cash-out” the certain number of credits. If the player does not wager all of the certain number of credits, the gaming machine 32 could either print a new scrip 60 having a value corresponding to the number of credits that went unwagered or store a number of bonus points in a new non-cashable voucher 31 in the database 26 corresponding to the number of credits that went unwagered. In a third example, the scrip 60 could be wagered at the sports book window. In this manner, the scrip 60 is exchanged for a wager confirmation slip that serves as confirmation of a wager on a particular sporting event, player, team, etc. The scrip 60 is not returned to the player.

Obviously, many modifications and variations of the present invention are possible in light of the above teachings. The invention may be practiced otherwise than as specifically described within the scope of the appended claims.

1. A method for redeeming bonus points from a computerized gaming incentive system comprising the steps of:
maintaining a player account associated with a player and a non-cashable voucher assigned to the player account wherein the non-cashable voucher includes a first number of bonus points representing a monetary value that may be wagered;
displaying to a user the non-cashable voucher including the monetary value;
allowing the user to enter an amount to be redeemed from the non-cashable voucher;
debiting a certain number of bonus points from the non-cashable voucher corresponding to the amount to be redeemed;
producing a scrip wagerable at a table game and valued at the amount to be redeemed.

2. A method as set forth in claim 1 further comprising the step of allowing the player to authorize the debiting of the certain number of bonus points.

3. A method as set forth in claim 2 wherein the step of allowing the player to authorize the debiting of the certain number of bonus points is further defined as the steps of:
allowing the player to enter a personal identification number (PIN); and
confirming the validity of the PIN.

4. A method as set forth in claim 1 further comprising the step of maintaining a cashable voucher assigned to the player account wherein the cashable voucher includes a second number of bonus points representing a monetary value and which may be exchanged for cash.

5. A method as set forth in claim 1 further comprising the step of printing a receipt to verify the debiting of the certain number of bonus points from the non-cashable voucher.

6. A method as set forth in claim 1 wherein the user is further defined as a casino employee.

7. A method as set forth in claim 1 wherein the user is further defined as the player.

8. A method of redeeming bonus points from a computerized gaming incentive system comprising the steps of:
maintaining a player account associated with a player and a plurality of vouchers assigned to the player account wherein each of the plurality of vouchers includes a number of bonus points representing a monetary value;
displaying to a user a list of vouchers assigned to the player account; and
allowing the user to select a voucher to be redeemed from the plurality of vouchers displayed.

9. A method as set forth in claim 8 further comprising the step of allowing the user to enter an amount to be redeemed from the voucher selected.

10. A method as set forth in claim 9 further comprising the step of debiting a certain number of bonus points from the voucher selected corresponding to the amount to be redeemed.

11. A method as set forth in claim 10 further comprising the step of printing a receipt to verify the debiting of the certain number of bonus points from the voucher selected.

12. A method as set forth in claim 10 further comprising the step of allowing the player to authorize the debiting of the certain number of bonus points.

13. A method as set forth in claim 12 wherein the step of allowing the player to authorize the debiting of the certain number of bonus points is further defined as the steps of:
allowing the player to enter a personal identification number (PIN); and
confirming the validity of the PIN.

14. A method as set forth in claim 10 wherein the voucher selected is further defined as a cashable voucher including a second number of bonus points representing a monetary value and which may be exchanged for cash.

15. A method as set forth in claim 10 wherein the voucher selected is further defined as a non-cashable voucher including a first number of bonus points representing a monetary value which may be wagered.

16. A method as set forth in claim 15 further comprising the step of producing a scrip wagerable at a table game and valued at the amount to be redeemed.

17. A method as set forth in claim 8 wherein the user is further defined as a casino employee.

18. A method as set forth in claim 8 wherein the user is further defined as the player.

19. A gaming incentive system comprising:
a computer for tracking a player account;
a database stored on the computer for storing a plurality of vouchers wherein each voucher includes a number of bonus points representing a monetary value;
a terminal coupled to the computer including a display for displaying to a user a list of vouchers assigned to the player account and a input device for allowing the user to select a voucher to be redeemed from the plurality of vouchers displayed.

20. A gaming incentive system as set forth in claim 19 wherein the terminal allows the user to enter an amount to be redeemed from the voucher selected.

21. A gaming incentive system as set forth in claim 20 wherein the computer debits a certain number of bonus points from the voucher selected corresponding to the amount to be redeemed.

22. A gaming incentive system as set forth in claim 21 further comprising a printer coupled to the terminal for printing a receipt to verify the debiting of the certain number of bonus points from the voucher selected.

23. A gaming incentive system as set forth in claim 19 wherein the terminal further includes a keypad for allowing the player to enter a personal identification number (PIN) and the terminal confirms the validity of the pin for authorizing the debiting of the certain number of bonus points.

24. A gaming incentive system as set forth in claim 19 wherein the voucher selected is further defined as a non-cashable voucher including a first number of bonus points representing a monetary value which may be wagered.

25. A gaming incentive system as set forth in claim 24 further comprising a printer for producing a scrip wagerable at a table game and valued at the amount to be redeemed.

26. A gaming incentive system as set forth in claim 19 further comprising a wireless hub coupled to the computer for transmitting and receiving data.

27. A gaming incentive system as set forth in claim 20 wherein the terminal is further defined as a wireless terminal device coupled with the wireless hub.
